(19) United States
(12) Patent Application Publication
(10) Pub. No.: US 2008/0254229 A1
(43) Pub. Date: Oct. 16, 2008

(54) Radiation Curable Coating Composition and Method

(76) Inventor: Randall T. Lake, Independence, KY (US)

Correspondence Address: THOMPSON HINE L.L.P.;Intellectual Property Group, P.O. BOX 8801, DAYTON, OH, 45401-8801, US

(21) Appl. No.: 12/088,953

(22) PCT Filed: Sep. 28, 2006
(86) PCT No.: PCT/US06/37598

§ 371 Date: Apr. 2, 2008

Related U.S. Application Data
(60) Provisional application No. 60/723,093, filed on Oct. 3, 2005.

(51) Int. Cl. C08F 2/48; C08L 33/04; C08J 3/28; C08F 2/46; C08G 18/00

(52) U.S. Cl. 427/508; 524/556; 522/153; 524/590; 522/162; 427/487

(57) ABSTRACT

The present invention relates to a composition for coating substrates and to methods for coating substrates using the composition. In general, the composition contains a prepolymer and a decorative effect additive, such as a pigment. The composition is radiation curable. In one embodiment, the composition is cured by electron beam energy. In another embodiment, the composition also contains a photoinitiator and is cured by ultraviolet (UV) energy. The composition coats substrates via a single curing process to provide a decorative coating, also referred to as a non-clear coat.

### RELATED APPLICATION

This application claims priority from U.S. Provisional Application Ser. No. 60/732,093 filed Oct. 3, 2005.

### FIELD OF THE INVENTION

The present invention relates to a radiation curable coating composition and to methods for coating a substrate using the composition to provide a decorative coating.

### BACKGROUND OF THE INVENTION

Current decorative coating compositions that are applied as a single coat on a substrate, e.g. a cell phone casing, typically fail to provide a “wet” look or a depth appearance. These coatings also tend to have pigment close to the surface such that over time the pigment exhibits a “washed out” or chalky appearance in areas exposed to outdoor ultraviolet (UV) light degradation. In addition, certain single coat decorative coatings generally have been cured using high energy thermal curing, such as melamine cure, suitable only for metal substrates. Other decorative coating compositions include multiple components that can only be mixed immediately prior to application on a substrate such as to enable the use of lower energy curing. And, certain single coat ultraviolet cured coatings appear to suffer from thermal cycle cracking, poor durability, poor mar resistance, and limited application. To overcome some of the aesthetic issues and to improve upon the exterior performance of certain single coat decorative coating compositions, clearcoats have been added either as second coats or applied wet-on-wet followed by a complete cure of both coatings at once. Accordingly, it would be desirable to provide a radiation curable coating composition for applying to a substrate, as a single coat, and curing thereon via a single process, such coating providing a decorative coating, including a wet look, and protection from UV light degradation.

In addition, substrates, e.g. cell phone casings, may be provided with an aesthetically appealing metallic appearance. This metallic appearance may be produced via electroplating and metallizing. Unfortunately, environmental disadvantages exist with each of these processes. More specifically, electroplating generates toxic by-products and metallizing generally requires a protective top coating and base coating material, which generally contain volatile organic compounds (VOC). As such, it would also be desirable to provide a coating composition, which includes at least a reduced VOC content, for coating a substrate to provide a decorative coating.

### SUMMARY OF THE INVENTION

The present invention relates to a composition for coating substrates and to methods for coating substrates using the composition. In general, the composition contains a prepolymer including one or more radiation curable acrylated monomers, oligomers, or combinations thereof, and a decorative effect additive, such as a pigment. In one embodiment, the composition is cured by electron beam energy. In another embodiment, the composition contains a photoinitiator and is cured by ultraviolet (UV) energy. The composition coats substrates via a single curing process to provide a decorative coating.

### DETAILED DESCRIPTION

The present invention is directed towards a radiation curable coating composition that contains a prepolymer and a decorative effect additive, such as a pigment. The composition is applied to a substrate and cured either by electron beam energy or, with the inclusion of a photoinitiator, by ultraviolet (UV) energy to provide a decorative coating, also referred to as a non-clear coat.

The prepolymer of the coating composition is an acrylate and/or (meth)acrylate monomer and/or oligomer. In one embodiment, the prepolymer is present in the composition at a concentration ranging from about 75% ^{w/w} to about 90% ^{w/w}. In another embodiment, the prepolymer is present in the composition at a concentration ranging from about 40% ^{w/w}, to about 99% ^{w/w} in the absence of solvent(s).

The decorative effect additive may include a metallic pigment and/or a non-metallic pigment. In one embodiment, the pigment is present in the composition at a concentration ranging from about 5% ^{w/w} to about 20% ^{w/w}. In another embodiment, the pigment is present in the composition at a concentration ranging from about 1% ^{w/w} to about 60% ^{w/w}.

A photoinitiator may be present in the composition as a cure agent. If present, in one embodiment, the photoinitiator is present in the composition at a concentration ranging from about 6% ^{w/w} to about 12% ^{w/w} in the absence of solvent(s). If present, in another embodiment, the photoinitiator is present in the composition at a concentration ranging from about 1% ^{w/w} to about 15% ^{w/w}.

Other components may also be present in the composition. As one example, one or more property promoting additive(s), including but not limited to a light stabilizer and/or a light absorber, may be present. In one embodiment, property promoting additive(s) may be present at a concentration ranging from about 0.1% ^{w/w} to about 40% ^{w/w}. In another embodiment, property promoting additive(s) may be present at a concentration less than about 31% ^{w/w}. As another example, one or more solvent(s) may be present. The concentration of solvent(s) may range from about 5% ^{w/w} to about 97% ^{w/w}.

In one embodiment, the composition includes one or more radiation curable acrylated monomers and/or oligomers, i.e. radiation curable prepolymers, and a decorative effect additive. In another embodiment, the composition includes one or more radiation curable acrylate monomers and/or oligomers, a decorative effect additive, and a photoinitiator. The radiation curable monomers and oligomers provide an active sight for polymerization, such as through the acrylate bond.

The radiation curable acrylated monomers may generally include a methacrylated monomer and, more specifically, may include 1,6 hexanediol diacrylate, 1,6 hexanediol methacrylate, neopentyl glycol diacrylate, neopentyl glycol dimethacrylate, tripropylene glycol diacrylate, propoxylated (2) neopentyls glycol diacrylate, trimethylpropane trimethacrylate, trimethylpropane triacrylate, tris (2-hydroxy ethyl) isocyanurate triacrylate, ethoxylated (3) trimethylpropane triacrylate, pentaerythritol triacrylate, propoxylated(3) trimethylpropane triacrylate, pentaerythritol tetraacrylte, dipentaerythritol oentaacrylate, ethoxylated (4) pentaerythritol tetraacrylate, metallic diacrylate, metallic dimethacrylate. Other acrylated monomers may include epoxy acrylates such as CN 104, 120, or 124 (Sartomer Company, Exton Pa.), Genomer™ 2253 (Rahn, Aurora Ill.), and Ebecryl® 745 or 3703 (Surface Specialties, Smyrna Ga.).

The radiation curable acrylated oligomers may generally include acrylated urethane oligomers, such as methacrylated urethane oligomers, and more specifically, may include trimethyl propane triacrylate or dipentaerythritol pentaacrylate. Other urethane oligomers may include CN 934, 962, 964, 966, 980, 981, 983, or 984 (Sartomer Company), Genomer™ 4312, 4302, 4305 (Rahn), or Ebecryl® 264, 284, 1290, or 8200 (Surface Specialties).

The decorative effect additive of the present invention may include silica, such as Aerosil® 200 or R972 (Degussa, Piscataway N.J.), Syloid Rad 2005, 2105, AL-1, or BN-1 (Grace Division, Columbia, Md.), or Sylysia 276 (Fuji Sylysia Chemical Ltd. of Kasugai, Aichi JP). The decorative effect additive also may include micas, such as Pearlescent Pigment Phoenix® PX 4542, 3001, 1542, 1251, 5000, or 1310 (Eckart America, L.P., Painesville Ohio), Unipearl® Copper Penny, Unipearl® Pearlescent Gold, or Unipearl® Pearlescent Silver (Degussa, Parsippany N.J.), SunMica® 4191, SunMica® Glittering White, SunMica® Iridescent Gold, SunMica® Iridescent Red, or SunMica® Sparkle White (Sun Chemical, Cincinnati Ohio).

Other decorative effect additives include pearls, dyes such as orasols or sanodyes, metals (e.g. flakes or powders), or pigments such as aluminum bronzes, zinc, copper, bronze, or brass, leafing and non-leafing aluminum pigments, powders or pastes, vacuum metallized pigments, pearlescent pigments, interference pigments, platelet-shaped effect pigments based on iron oxide, metal oxide mica pigments, liquid crystal effect pigments, and holographic pigments.

Copper flakes specifically may include Standart® Copper Powder (Eckart America, L.P.), copper powder may include Supergold™ 10/0 Copper or Supergold™ 17/0 Fire Red 04-20197 (Eckart America, L.P.), and copper/zinc flakes may include Supergold™ 10/0 Rich Pale Gold (Eckart America, L.P.). Vacuum metallized pigment may include StarBrite™ 2100EAC (Silberline®, Tamaqua Pa.). Holographic pigment may include GP 144 SV (Silberline®). Aluminum powder may include Eckart 6-2600, 6-3500, 2-382, or ZN Flake 2GTT 04G0003 (Eckart America, L.P.). Aluminum paste may include 40 Stapa® or ML55350 (Eckart America, L.P.), SilberCote™ PC-8152Z, Sparkle Silver 5500, Sparkle Silver Premier 553, Sparkle Silver Premier 751, Sparkle Silvet® 950-20-P, Tufflake™ 4700, EternaBrite® Premier 351, EternaBrite® Premier 255, or EternaBrite® Premier 251 (all available from Silberline®).

The decorative effect additive also may include organic and inorganic pigments, such as anthraquinone pigments, metal complex pigments, titanium dioxide, zinc shite, black pigments, chromatic pigments, cobalt blue, ultramarine blue, ultramarine violet, etc. The organic pigment may specifically include 850-0001 TiO2 White or 850-9940 Black (Degussa). The inorganic pigment specifically may include Variocrom® Magic Gold L1400, Variocrom® Magic PurpleL520, Variocrom® Magic Red L4420 (BASF, Charlotte N.C.), 13-7014 Hostaperm Pink E Trans, or 13-7019 Hostaperm Pink EB Trans (Clariant Corporation, Coventry R.I.). Other colorants may include Sanodye MF Blue AP 150 or Sanodye MF Violet 3D P (Clariant), Orasol Red 3GL, Orasol Blue GN, Orasol Yellow 4GN, Orasol Yellow 2RLN, Orasol Orange G, Orasol Blue GL, or Orasol Black CN (CIBA, Tarrytown N.Y.).

The photoinitiator, if present, may include, for example, one or more ketones and, more specifically, may include trimethylbenzophenone, polymeric hydroxy ketone, benzophenone, 2-hydroxy-2-methylpropiophenone, or 4,4′-bis(diethylamino)benzophenone (IGM Resins Inc., Ft. Wayne Ind.), 2,4,6-trimethylbenzoylphenyl-phosphineoxide, isopropylthioxanthone, dimethylhydroxyacetophenone, 1-hydroxycyclohexylphenylketone, benzyl dimethyl ketal, or mixtures thereof. The photoinitiator may also include Omnirad 1000 (IGM Resins, Inc).

The composition may also include an aqueous or non-aqueous solvent(s), such as water, acetates, ketones, ethers, alcohols, and aliphatic hydrocarbons. Specific examples include, but are not limited to, toluene, acetone, n-butyl acetate, isopropanol, butanol, diacetone alcohol, ethylene glycol monobutyl ether, methyl ethyl ketone, methyl isobutyl ketone, and/or tertiary butyl acetate. In one embodiment, the solvent(s) provides for spray application of the coating, which allows the decorative effect additive, for example a metal flake, to settle adjacent the substrate, that is, towards the bottom of the coating during application. In one embodiment, the solvent is evaporated or, otherwise, flashed off after the substrate is coated, as further discussed below.

In one embodiment, the radiation curable acrylic monomer(s) and/or oligomer(s) is present in a range of about 40% ^{w/w} to about 99% ^{w/w} of the composition in the absence of solvent(s), or about 2% ^{w/w} to about 95% ^{w/w} in the presence of solvent(s). In another embodiment, the radiation curable component is present in a range of about 75% ^{w/w} to about 90% ^{w/w} of the composition in the absence of solvent(s). In another embodiment, the radiation curable component is about 80% ^{w/w} of the embodiment in the absence of solvent(s).

In one embodiment, the decorative effect additive is present in a range of about 1% ^{w/w} to about 60% ^{w/w} of the composition in the absence of solvents, or about 0.05% ^{w/w} to about 55% ^{w/w} of the composition in the presence of solvent(s). In another embodiment, the decorative effect additive is present in a range of about 5% ^{w/w} to about 20% ^{w/w} of the composition in the absence of solvent(s). In another embodiment, the decorative effect additive is present at about 10% ^{w/w} by weight of the embodiment in the absence of solvent(s).

In one embodiment, the photoinitiator is present in a range of about 1% ^{w/w} to about 15% ^{w/w} of the composition in the absence of solvent(s), or about 0.05% ^{w/w} to about 14% ^{w/w} of the composition in the presence of solvent(s). In another embodiment, the photoinitiator is present in a range of about 6% ^{w/w} to about 12% ^{w/w} of the composition in the absence of solvent(s). In another embodiment, the photoinitiator is present at about 9.5% ^{w/w} of the embodiment in the absence of solvent(s).

In one embodiment, the solvent(s) is present in a range of about 5% ^{w/w} to about 97% ^{w/w} of the composition. In another embodiment, the solvent(s) is present in a range greater than 5% ^{w/w} to about 96% ^{w/w} of the composition. In yet another embodiment, the solvent(s) is present in a range of about 50% ^{w/w} to about 95% ^{w/w} of the composition. In another embodiment, the solvent(s) is about 75% ^{w/w} of the composition.

The inventive composition may further include a property-promoting additive, such as a light stabilizer and/or absorber, for example, ultraviolet absorbers or hindered amine light stabilizers and/or absorbers. The UV absorber may include benzotriazole absorbers, triazine absorbers, salicylic acid derivative absorbers, or benzophenone absorbers. Other UV absorbers may include Tinuvin® 1130, R796, or 405 (CIBA). The hindered amine light stabilizer may include a hindered piperidine and, more specifically, may include Tinuvin® 384-2 or 292 (CIBA). The property additive may also include Byk 301 (Byk Chemie, Wesel Germany), or Syloid Rad 2005 (WR Grace, Baltimore Md.).

Other property promoting additives can include photosynergists, adhesion promoters, flow aids, wetting agents, rheology modifiers, nanoparticles (hydrophilic and/or hydrophobic), cellulosics, melamines, and/or blocked isocyanates. The adhesion promoter may include CAB 551-0.01 (Eastman Chemical, Kingsport Tenn.), Ebcryl168 or 170 (Surface Specialties), Genorad 40 (Rahn), Paraloid™ B-66, B-64, B-67, or B-84 (Rohm and Haas, Philadelphia Pa.).

In one embodiment, the property-promoting additive is present in the composition at a range of about 0.1% ^{w/w} to about 40% ^{w/w} of the composition in the absence of solvent(s), or not greater than about 38% ^{w/w} by weight of the composition in the presence of solvent(s). In another embodiment, the property-promoting additive is present in the composition at a range of not greater than about 31% ^{w/w} of the composition in the absence of solvent(s). In another embodiment, the property-promoting additive is not greater than about 1% ^{w/w} of the composition in the absence of solvent(s).

In one embodiment, the hindered amine light stabilizer and/or absorber is present in the composition at a range of about 1% ^{w/w} to about 8% ^{w/w} of the composition. In another embodiment, the hindered amine light stabilizer and/or absorber is present in the composition at a range of about 3% ^{w/w} to about 5% ^{w/w} of the composition in the absence of solvent(s). In another embodiment, the hindered amine light stabilizer and/or absorber is about 4% ^{w/w} of the composition in the absence of solvent(s).

Accordingly, in one embodiment, the radiation curable composition can include, in the absence of solvent(s), an acrylated oligomer in a range of about 2% ^{w/w} to about 95% ^{w/w} of the composition, a decorative effect additive in a range of about 0.05% ^{w/w} to about 55% ^{w/w} of the composition, a property promoting additive present at less than about 38% ^{w/w} of the composition, and a photoinitiator in a range of about 6% ^{w/w} to about 12% ^{w/w} of the composition. The weight percentages of each compound of the aforementioned coating composition may be adjusted downward to optionally include about 50% ^{w/w} to about 95% ^{w/w} total solvent(s) content.

In another embodiment, the radiation curable composition includes an acrylated urethane such as Ebecryl® 264, a first acrylated monomer such as trimethyl propane triacrylate, a second acrylated monomer such as dipentaerythritol pentaacrylate, a photoinitiator such as Omnirad 1000, a decorative effect additive such as Silberline Sparkle Silver® Premier 751, a first property additive such as Byk 301, a second property additive such as Syloid Rad 2005, and a solvent such as toluene, in the ranges as discussed above, by weight of the composition to provide a decorative coating on a substrate.

The coating process includes combining the compounds of the coating composition in the desired weight percentages, as indicated above, then coating and curing the composition on the substrate, via a single curing process, to produce a crosslinked polymeric coating that adheres, or bonds, to the substrate. The coating composition may provide improved wear resistance, durability, thermal stability, crack resistance, chemical resistance, stain resistance, weather resistance, hardness, mar resistance, flexibility, moisture resistance, adhesion, etc., as well as additional functional characteristics such as conductivity, hardness, durability, etc.

The composition can be sprayed, airless sprayed, rotary atomized, roll coated, flow coated, and the like onto the substrate, The substrate may be dipped into the coating composition. In one embodiment, the coating is applied to the substrate at a thickness of no less than about 2 microns. In another embodiment, the coating is applied onto the substrate at a thickness of no less than about 12 microns. In another embodiment, the coating is applied to the substrate at a thickness of about 17 microns. It should be understood that other thicknesses may be utilized. In addition, the composition may be applied to the substrate only once or may be applied multiple times to provide multiple coats, also referred to as wet on wet coats, of the same composition, which then are cured, as discussed below, in a single process to provide a decorative coating.

The substrate may include, but is not limited to, a hand held electronic device (a cell phone, personal entertainment device, CD player, global positioning system, PDA, calculator), a computer or computer casing, cell phone casing, camera, video recorder, DVD player, toys, cosmetic cases, automobiles, automotive handles, automotive bezels, automotive trim, automotive side markers, automotive tail lamps, ceiling lighting louvers, wheel covers, automotive fascias, bicycles, tractors, wall outlet covers, lamp bases, ceiling fan housings and trim, etc. The substrate may be made of or include glass, leather, glass fibers, composites, wood including sealed wood, and metals such as aluminum or alloys thereof, steel including prepared steel (e.g., coated, etc.), galvanized steel, zinc alloy plated steel, stainless steel, tin plated steel, cast metals, etc.

The substrate may also include plastics such as acrylonitrile butadiene styrene (ABS), acrylonitrile-methyl methacrylate (AMMA), acrylonitrile-acrylate terpolymer (ASA), polyether ether ketone (PEEK), cellulose acetate (CA), cellulose acetate butyrate (CAB), ethylene propylene (EP), urea formaldehyde (UF), carbon fiber (CF), melamine formaldehyde (MF), phenolic formaldehyde (PF), polyacrylonitrile (PAN), polyethylene (PE), high density polyethylene (HDPE), high density polyethylene high molecular weight (HDPE-HMW), high density polyethylene ultra high molecular weight (HDPE-UHMW), medium density polyethylene (MDPE), very low density polyethylene (VLDPE), oly(styrene maleic anhydride) (SMA), poly(styrene acrylonitrile maleic anhydride) (SAMA), poly(acrylonitrile ethylene propylene styrene) (AES), polymethacrylate butadiene styrene (MBS), polybutadiene terephthalate/polycarbonate/acrylonitrile butadiene styrene copolymer (PBT/PC/ABS), low density polyethylene (LDPE), linear low density polyethylene (LLDPE), ultrahigh molecular weight polyethylene (UHMWPE), polycarbonate/acrylonitrile butadiene styrene (PC/ABS), polycarbonate/polybutadiene terphthalate (PC/PBT), polycarbonate/polyarolate (PC/PA), polyethylene terphthalate (PET), polymethylmethacrylic (PMMA), polypropylene (PP) including prepared polypropylene (e.g. flame treated, etc.), polystyrene (PS), styrene butadiene (SB), polyurethane (PUR), styrene acrylonitrile (SAN), phenylene ether copolymer (PPE), polybutadiene terephthalate (PBT), polyoxymethylene (POM), polyurethane reaction injection molded (PUR-RIM), sheet molded compound (SMC), bulk molded compound (BMC), polypropylene-ethylene propylene diene monomer (PP-EPDM), unsaturated polyester (UP), polyphenylene sulfide (PPS), polyphenylene oxide (PPO), polycarbonate (PC), polyvinyl chloride (PVC), nylon modified polyphenyl oxide, acetal, glass mat polyester (GMT), polyether sulfone, polyester imide, polyester thermal sheet, polyester thermal plastics, polyester elastomer, polyarylate, polyhexamethylene-adipamide (nylon 6/6), polycaprolactam (nylon 6), nylon modified polyphenyl oxide, polyether sulfone (PES), polyether imide (PEI), thermoplastic polyolefin (TPO), thermoplastic polyurethane (TPUR), fiber reinforced polyesters, fiber reinforced polyurethanes, and fiber reinforced polycarbonates. In addition, the above disclosed substrates further may be coated, seal primed, etc.

Curing of the coating composition is accomplished by radiation curing. Radiation curing polymerizes and cures coatings using radiant energy. The sources of radiant energy can vary. For purposes herein, the source is provided by an electron beam or ultraviolet (UV) light. Electron beams typically include higher energy than UV radiation, and their generated electrons have sufficient energy to initiate polymerization and crosslinking of the monomers and/or oligomers. Unlike UV curing, electron beam curing does not require the use of a photoinitiator, but a photoinitiator may still be used. In contrast, UV curing requires the use of a photoinitiator to produce the polymerization reaction of monomers and/or oligomers to form a crosslinked polymer. Also, concerning use of electron beam radiation, this radiation allows for curing of the radiation curable composition on three-dimensional (3D) objects or surfaces, such as cell phone substrates, in addition to flat line cure or curing of the composition on flat objects.

The source of radiation typically is a light source, such as from a lamp. For electron beam radiation, four types of lamps that may be used as light sources include high voltage, low voltage, scanning, and sealed beam. The UV light includes a wavelength in the spectral range of between about 200 nm to about 450 nm. This light may be provided by a mercury vapor lamp, etc.

If curing by ultraviolet or electron beam radiation, cure of the coating composition is achieved by exposure of the coated substrate at a desired dosage for a desired period of time. In one embodiment, the dosage of the ultraviolet radiation, also referred to as energy density, is about 300 mJ/cm² to about 20000 mJ/cm². In another embodiment, the dosage of the UV radiation is about 800 mJ/cm² to about 3500 mJ/cm². In one embodiment, the dosage of the electron beam radiation is about 1 Megarad to about 40 Megarad. In another embodiment, the dosage of the electron beam radiation is about 3 Megarad to about 36 Megarad. In yet another embodiment, the dosage of the electron beam radiation for flat line cure, i.e. for curing on flat surfaces, is about 3 Megarad to about 4 Megarad in an inert atmosphere and where the coating is about 100 microns thick. In another embodiment, the dosage of the electron beam radiation for 3D cure, i.e. for curing on a 3D object or surface, is about 9 Megarad to about 12 Megarad in an inert atmosphere and where the coating is about 100 microns thick. In yet another embodiment, the dosage of the electron beam radiation for 3D cure is about 30 Megarad to about 40 Megarad where the coating is about 17 microns thick.

In one embodiment, the curing time may range from about 10 seconds to about 15 minutes. In another embodiment, the curing time may range from about 60 seconds to about 10 minutes. Heat may optionally be applied during the curing process to reduce the cure time.

If a solvent is provided in the coating composition, solvent flash off, or evaporation thereof, can be achieved, after the substrate is coated. This may be accomplished by room temperature air drying and may be accelerated by applying heat, such as by heated air or infrared radiation.

The coating composition, after UV or electron beam curing, is polymerized and bonds to the substrate such as to provide a decorative finish.

A non-limiting example of a radiation curable coating composition of the present invention is disclosed below.

### EXAMPLE 1

ACJ-92

| | | | | % Solids |
|---|---|---|---|---|
| | | | % Solids in | in |
| | | | each | absence |
| Description | Raw Material | % Weight | component | of solvent |
| Acrylated Urethane | Ebecryl ® 264 | 7.80 | 7.8 | 32.24 |
| Acrylated Monomer | TMPTA | 7.80 | 7.8 | 32.24 |
| Acrylated Monomer | SR399 | 3.90 | 3.9 | 16.12 |
| Property additive | Byk 301 | 0.05 | 0.025 | 0.10 |
| Photoinitiator | Omnirad 1000 | 2.20 | 2.2 | 9.09 |
| Solvent | Toluene | 74.85 | | |
| Decorative effect additive | Silberline Sparkle Silver ® | 3.10 | 2.17 | 8.97 |
| | Premier 751 | | | |
| Decorative effect additive | Syloid Rad 2005 | 0.30 | 0.3 | 1.24 |
| | Total | 100.00 | 24.195 | 100.00 |

To begin preparation of the composition, about 37.4% ^{w/w} toluene is added into a first vessel having a low shear blade. To this solvent, the Siberline Sparkle Silver® Premier 751 is slowly added under agitation. Upon complete addition, the solution is agitated for 20 minutes.

In a second empty vessel fitted with a low shear blade, the following ingredients are added under agitation: 7.8% ^{w/w} EB264, 7.8% ^{w/w} TMPTA, 3.9% ^{w/w} SR399 and 2.2% ^{w/w} of Omnirad 1000. After 10 minutes of agitation, 0.3% ^{w/w} Syloid Rad 2005 is added. This mixture is agitated for 20 minutes then the remaining 37.45% ^{w/w} toluene is added, which is followed by 0.05% ^{w/w} Byk 301. The stirring blade is removed and the contents of this second vessel are slowly added to the contents of the first vessel, followed by 10 minutes of mixing.

The radiation curable coating composition, ACJ-92, was spray applied at 45 psi to a Cycloloy MG38-3501 substrate (GE Plastics, Mt. Vernon Ill.), which is a substrate composed of a polycarbonate ABS blend and typically used for cell phone casings. Three wet coats of ACJ-92 were applied to achieve a film thickness of about 17 microns upon drying. After spray application of the third coating, the substrate was allowed to sit at room temperature (22° C.) for three minutes to evaporate, or flash off, the solvent. The coated substrate was then subjected to a thermal solvent flash off temperature of 65° C. for a period of 10 minutes. This was followed by an exposure to a mercury vapor UV light source operating at 400 watts per inch emitting a wavelength of about 200 nm to about 400 nm to begin the curing process by activating polymerization of the acrylated monomers and urethane oligomer. To complete the curing process, the coated substrate was exposed to the UV light until a dosage of about 4.17 J/cm² with an irradiance of about 389 mW/cm² as measured by a compact radiometer IL-393 (International Light, Newburyport Mass.) was achieved. The following tests were performed to evaluate various characteristics of the cured coating composition.

In one test, the radiation cured composition of Example I (ACJ-92) was subjected to a tape adhesion test (based upon ASTM D3359). In this test, a “Cross Hatch Cutter Kit” was used with a 2 mm spacing knife blade and 898 adhesive tape (3M, Minneapolis Minn.). A lattice pattern with six evenly spaced cuts in each direction was made. The 898 adhesive tape was applied over the lattice area and then removed. The area of the coating that was removed from within the squares was compared on a percentage basis with the total area of the squares, with 100% being a perfect rating and 0% being a total loss of coating. In this instance, the testing of ACJ-92 the rating of 100% was obtained initially.

In another test, the radiation cured composition of Example I (ACJ-92) was subjected to a heated water immersion test, In this test, deionized water was heated to a temperature of 75° C. The substrate was immersed for 72 hours in the deionized heated water. The parts were removed and immediately dried. At 10 minutes after removal, the parts were tape adhesion tested. 100% adhesion was observed.

In another test, the radiation curable composition of Example I (ACJ-92) was subjected to a water immersion test. In this test, the substrate was submerged in deionized water adjusted to pH 4.0 with hydrochloric acid. After four hours of submersion, the parts were removed and tape adhesion tested. ACJ-92 received a rating of 100%.

In another test, the radiation curable composition of Example I (ACJ-92) was subjected to a pencil hardness test (based upon ASTM D3363). In this test, pencil leads of different hardness values were forced against the coating surface. More specifically, leads range in hardness from soft to hard, as follows: 6B, 5B, 4B, 3B, 2B, B, HB, F, H, 2H, 3H, 4H, 5H, and 6H. The lead was first squared against fine abrasive paper to eliminate the sharp point. The pencil was then placed at a 45° angle to the coating and pushed against the surface. The lead hardness was increased until the coating was cut into and removed from the substrate. The lead number immediately softer is the rating given to the hardness of the coating. In testing ACJ-92, the rating was “2H,” which indicated that the 3H pencil cut into the coating and the 2H did not.

### EXAMPLE 2

ACJ-124

| | | | % Solids in | % Solids in |
|---|---|---|---|---|
| | | % | each | absence |
| Description | Raw Material | Weight | component | of solvent |
| Acrylated Urethane | Ebecryl ® 264 | 7.80 | 7.8 | 31.61 |
| Acrylated Monomer | TMPTA | 7.80 | 7.8 | 31.61 |
| Acrylated Monomer | SR399 | 3.90 | 3.9 | 15.81 |
| Property additive | Byk 301 | 0.05 | 0.025 | 0.10 |
| Photoinitiator | Omnirad 1000 | 2.20 | 2.2 | 8.92 |
| Solvent | Toluene | 74.37 | | |
| Decorative effect | Silberline Sparkle Silver ® | 3.10 | 2.17 | 8.79 |
| additive | Premier 751 | | | |
| Decorative effect | Orasol Blue GL | 0.48 | .48 | 1.95 |
| additive | | | | |
| Decorative effect | Syloid Rad 2005 | 0.30 | 0.3 | 1.22 |
| additive | | | | |
| | Total | 100.00 | 24.675 | 100.00 |

The composition (ACJ-124) was prepared using the same method as Example 1 but Orsol Blue GL was added immediately after Syloid Rad 2005. The same performance was obtained as in Example 1, but the appearance was of a blue metallic.

### EXAMPLE 3

ACJ-135

| | | | | % |
|---|---|---|---|---|
| | | | | Solids in |
| | | | % Solids in | absence |
| | | % | each | of |
| Description | Raw Material | Weight | component | solvent |
| Acrylated Monomer | TMPTA | 14.6 | 14.6 | 48.67 |
| Photoinitiator | Omnirad 1000 | 1.5 | 1.5 | 5 |
| Decorative effect | Polytrend ® 850-0001 (polyester | 4.6 | 4.6 | 15.33 |
| additive | based TiO2 dispersion by | | | |
| | Degussa) | | | |
| Property additive | Paraloid ™ B-66 | 9.3 | 9.3 | 31.00 |
| Solvent | Acetone | 70.0 | | |
| | Total | 100.00 | 30 | 100.00 |

B-66 can be predissolved to 50% ^{w/w} in acetone and the remaining ingredients can be added to this solution in any order under low shear. Once all of the remaining ingredients are added, the resulting mix can remain under agitation for 20 minutes. The composition (ACJ-135) was applied over Pulse 830 (Dow Chemical Company, Midland Mich.) to a dry thickness of 12 microns. The curing and solvent flash conditions were the same as in Example 1. In Example 3, the same performance was obtained as in Example 1 but the appearance was white in color.

### EXAMPLE 4

ACJ-136

| | | | | % |
|---|---|---|---|---|
| | | | | Solids in |
| | | | % Solids in | absence |
| | | % | each | of |
| Description | Raw Material | Weight | component | solvent |
| Acrylated Urethane | CN981 | 14.6 | 14.6 | 42.94 |
| Photoinitiator | Irgacure ® 1850 | 1.5 | 1.5 | 4.41 |
| Decorative effect | Polytrend ® 850-0001 (polyester | 4.6 | 4.6 | 13.53 |
| additive | based TiO2 dispersion by | | | |
| | Degussa) | | | |
| Property additive | Paraloid ™ B-66 | 9.3 | 9.3 | 27.35 |
| Property additive | Tinuvin ® 405 | 2 | 2 | 5.88 |
| Property additive | Tinuvin ® 152 | 2 | 2 | 5.88 |
| Solvent | Acetone | 66.0 | | |
| | Total | 100.00 | 34 | 100.00 |

B-66 can be predissolved to a 50% ^{w/w} in acetone and the remaining ingredients can be added to the solution in any order under low shear. Once all of the remaining ingredients are added, the resulting mix can remain under agitation for 20 minutes. The curing and solvent flash conditions are the same as in Example 1. In Example 4, exterior durability may be determined according to exposure to accelerated testing in a carbon or Xenon arc weatherometer, Equatorial Mount with Mirror for Acceleration (EMMA®) testing, Equatorial Mount with Mirror for Acceleration with Water (EMMAQUA®), South Florida testing, Arizona testing, or direct use.

With respect to Examples 1-4, electron beam radiation may be used to cure the radiation curable coating compositions. More specifically, the photoinitiator in each Example 1-4 may be eliminated and each composition prepared as stated above. The curing and solvent flash conditions are the same as discussed above but for the use of electron beam radiation rather than UV radiation. Accordingly, any suitable electron beam lamp may be used to provide a dosage of radiation from about 30 Megarad to about 40 Megarad to effect complete cure of the coated composition. Cured performance may be determined according to the testing methods discussed above.

Other variations or embodiments of the invention will also be apparent to one of ordinary skill in the art from the above description and examples. Thus, the forgoing embodiments are not to be construed as limiting the scope of this invention.

What is claimed is:

1. A method for coating a substrate, the method comprising
applying a radiation curable coating of a single undifferentiated composition to a substrate, the coating composition comprising
one or more radiation curable components chosen from acrylated monomers, oligomers, or combinations thereof, and
a decorative effect additive, and
exposing the coated substrate to electron beam radiation such that the radiation curable composition cures on the substrate to provide a decorative coating.

2. The method of claim 1 wherein the substrate is three dimensional.

3. The method of claim 1 wherein the applying step comprises spraying a radiation curable coating composition on the nonmetal substrate.

4. The method of claim 1 wherein the radiation curable component is present in a range of about 40% ^{w/w} to about 99% ^{w/w} in the absence of solvent and the decorative effect additive is present in a range of about 1% ^{w/w} to about 60% ^{w/w} in the absence of solvent.

5. The method of claim 1 wherein the radiation curable component is present in a range of about 2% ^{w/w} to about 95% ^{w/w} in the presence of solvent and the decorative effect additive is present in a range of about 0.05% ^{w/w} to about 55% ^{w/w} the presence of solvent.

6. A method for coating a substrate, the method comprising
applying a radiation curable coating of a single undifferentiated composition to the substrate, the coating composition comprising
at least one radiation curable acrylated urethane oligomer,
a decorative effect additive, and
a photoinitiator, and
exposing the coated substrate to ultraviolet light such that the radiation curable composition cures on the substrate to provide a decorative coating.

7. The method of claim 6 wherein the applying step comprises spraying a radiation curable coating composition on the substrate.

8. The method of claim 6 wherein the substrate is three dimensional.

9. The method of claim 6 wherein the radiation curable component is present in a range of about 40% ^{w/w} to about 99% ^{w/w} in the absence of solvent and the decorative effect additive is present in a range of about 1% ^{w/w} to about 60% ^{w/w} in the absence of solvent.

10. The method of claim 6 wherein the radiation curable coating composition further includes a solvent present in a range of about 5% ^{w/w} to about 97% ^{w/w} of the composition.

11. A method for coating a substrate, the method comprising
applying a radiation curable coating of a single undifferentiated composition to the substrate, the coating composition comprising
one or more radiation curable components chosen from acrylated monomers, oligomers, or combinations thereof,
a decorative effect additive,
a photoinitiator, and
a solvent present in a range of greater than 5% ^{w/w} to about 96% ^{w/w} of the composition, and
exposing the coated substrate to ultraviolet light such that the radiation curable composition cures on the substrate to provide a decorative coating.

12. The method of claim 11 wherein the applying step comprises spraying a radiation curable coating composition on the substrate.

13. The method of claim 11 wherein the substrate is three dimensional.

14. The method of claim 11 wherein the radiation curable component is present in a range of about 2% ^{w/w} to about 95% ^{w/w} and the decorative effect additive is present in a range of about 0.05% ^{w/w} to about 55% ^{w/w}.

15. A radiation curable coating composition comprising
at least one radiation curable component chosen from acrylated monomers, oligomers, or combinations thereof, wherein the radiation curable component is present in a range of about 2% ^{w/w} to about 95% ^{w/w};
a decorative effect additive in a range of about 0.05% ^{w/w} about 55% ^{w/w}; and
a solvent in a range of greater than 5% ^{w/w} to about 96% ^{w/w}.

16. The composition of claim 15 further including a photoinitiator present in a range of about 0.05% ^{w/w} to about 14% ^{w/w}.

17. A radiation curable coating composition comprising
at least one radiation curable component chosen from an acrylated urethane oligomer, wherein the radiation curable component is present in a range of about 40% ^{w/w} to about 99% ^{w/w} in the absence of solvents; and
a decorative effect additive in a range of about 1% ^{w/w} to about 60% ^{w/w} in the absence of solvent.

18. The composition of claim 17 further including a photoinitiator present in a range of about 1% ^{w/w} to about 15% ^{w/w} of the composition.

19. The composition of claim 17 further including a solvent present in a range of greater than 5% ^{w/w} to about 96% ^{w/w}.
